(19) United States
(12) Patent Application Publication
(10) Pub. No.: US 2021/0016321 A1
(43) Pub. Date: Jan. 21, 2021

(54) ELECTROMAGNETIC DRIVING DEVICE

(71) Applicant: AAC Technologies Pte. Ltd., Singapore city (SG)

(72) Inventors: Xudong Yan, Shenzhen (CN); Keyong Zhou, Shenzhen (CN)

(21) Appl. No.: 16/930,295

(22) Filed: Jul. 15, 2020

(30) Foreign Application Priority Data
Jul. 16, 2019 (CN) 201921118963.6

(51) Int. Cl. B06B 1/04; H02K 5/04; H02K 33/16; G10K 9/13

(52) U.S. Cl. CPC B06B 1/045; G10K 9/13; H02K 33/16; H02K 5/04

(57) ABSTRACT

An electromagnetic driving device includes a panel, and an electromagnetic driver attached to the panel and configured to vibrate the panel in a vibrating direction to generate sound. The electromagnetic driver includes a housing, a cover, and a driving unit disposed between the housing and the cover. The cover is attached to the panel. The driving unit includes a magnetic core, a coil wound around the magnetic core and mounted to the cover with a gap formed between the coil and the housing, and a pair of magnetic assemblies mounted to the housing and disposed on opposite axial sides of the coil. Magnetic fluxes emitted from one of the magnetic assemblies arrive at the other of the magnetic assemblies after passing through the coil. Screens of mobile terminals using the electromagnetic driving device have good acoustic effect and good reliability.

### CROSS REFERENCE TO RELATED APPLICATIONS

This non-provisional patent application claims priority of Chinese Application 201921118963.6, filed on Jul. 16, 2019, the content of which is incorporated herein by reference.

### FIELD OF THE INVENTION

The present disclosure relates to the field of electroacoustic conversion, and in particular to a portable electromagnetic driving device.

### BACKGROUND

With the advent of the mobile internet era, the number of smart mobile devices has been continuesly increasing. Among various mobile devices, mobile phones are undoubtedly the most common and most portable mobile devices. Currently, the functions of mobile phones are very diverse, and one of them is the high-quality music function. With the growing demand for larger screen space available for user operation and better acoustic performance of the mobile phones, screen sounding technology has become a trend in the mobile phone industry. Electromagnetic driving devices are important parts for the mobile phones with the screen sounding technology.

An electromagnetic driving device in the related art generally comprises a casing, a screen covering the casing, and a driver. The casing and the screen cooperatively form an accommodation space, and the driver is installed in the accommodation space for driving the screen to vibrate and generate sound.

However, the mobile terminal devices of the related art generally adopt a piezoelectric-type driver, a moving coil type driver or an electromagnetic-type driver. The piezoelectric-type driver requires a large voltage, which means the mobile terminal needs to adjust the battery arrangement and the cost is therefore increased. The moving coil type driver has a limited driving force which limits the acoustic performance of the mobile terminal. Although the electromagnetic type driver of the related art can meet the driving force requirement, it makes the screen subject to a great suction force and imposes a high assembly requirement for the screen and middle frame of the mobile terminal device, which reduces the reliability and assemblability of the screen.

Therefore, it is desired to provide an improved electromagnetic driving device which can overcome at least one of the above problems.

### SUMMARY

Accordingly, the present disclosure is directed to an electromagnetic driving device with improved acoustic performance and reliability.

In one aspect, the present disclosure provides an electromagnetic driving device comprising a panel and an electromagnetic driver attached to the panel and configured to vibrate the panel in a vibrating direction to generate sound. The electromagnetic driver comprises a housing, a cover spaced from the housing, and a driving unit disposed between the housing and the cover, one of the housing and the cover being attached to the panel. The driving unit comprises a magnetic core made of magnetic conductive material, a coil wound around the magnetic core and mounted to the cover with a gap formed between the coil and the housing, and at least one pair of magnetic assemblies mounted to the housing, the coil defining an axial direction around which the coil is wound, the axial direction being perpendicular to the vibrating direction, the at least one pair of magnetic assemblies being disposed on opposite axial sides of the coil, magnetic flux emitted from one of the at least one pair of magnetic assemblies arriving at the other of the at least one pair of magnetic assemblies after passing through the coil.

In some embodiments, the magnetic core is made of iron.

In some embodiments, the magnetic core comprises a surface on which a layer of copper is covered to form a short-circuit ring.

In some embodiments, the magnetic assembly comprises a first magnetic member, a second magnetic member and a third magnetic member, the first magnetic member being sandwiched between the second magnetic member and the third magnetic member in the vibrating direction.

In some embodiments, the first magnetic member is polarized in the vibrating direction, and the second magnetic member and the third magnetic member are polarized in the axial direction of the coil, polarized directions of the second magnetic member and the third magnetic member being reversed to each other.

In some embodiments, the first magnetic member is a permanent magnet, and the second and third magnetic members are made of permanent magnet material or magnetic conductive material.

In some embodiments, the first magnetic member is made of magnetic conductive material, and the second and third magnetic members are made of permanent magnet material.

In some embodiments, polarized directions of the first magnetic members of the at least one pair of magnetic assemblies are reversed to each other.

In some embodiments, the housing comprises an bottom plate and a side wall extending from a periphery of the bottom plate toward the cover, the bottom plate defining a recess for forming the gap between the coil and the bottom plate of the housing, the side wall surrounding the driving unit.

In some embodiments, the bottom plate has a rectangular shape, the side wall comprises a pair of first side plates and a pair of second side plates connected between the first side plates, the recessing extending from one of the second side plates to the other of the second side plates.

In some embodiments, the cover comprises a surface facing the coil, a protrusion protrudes from the surface in the vibrating direction, and the coil is fixed to the protrusion.

In some embodiments, an orthographic projection of the coil in the axial direction toward the magnetic assembly falls into a periphery of the magnetic assembly.

In another aspect, the present disclosure provides an electromagnetic driver configured to drive a screen of a mobile terminal device to vibrate and sound. The electromagnetic driver comprises a housing, a driving unit received in the housing, and a cover covering the driving unit.

The driving unit comprises a coil mounted to the cover, and two magnetic assemblies mounted to the housing, the coil defining an axial direction around which the coil is wound, the coil comprising two parts spaced arranged in a vibrating direction along which the coil and the cover is vibrated when the coil is energized. Each magnetic assembly comprises a first magnetic member, a second magnetic member and a third magnetic member, the first magnetic member being sandwiched between the second magnetic member and the third magnetic member in the vibrating direction, the second magnetic member and the third magnetic member respectively facing the two parts of the coil in the axial direction, magnetic flux emitted from one of the second magnetic members arriving at the other of the second magnetic members after passing through one of the two parts of the coil, magnetic flux emitted from one of the third magnetic members arriving at the other of the third magnetic members after passing through the other of the two parts of the coil.

In some embodiments, the first magnetic member is polarized in the vibrating direction, the second magnetic member and the third magnetic member are polarized in the axial direction of the coil, polarized directions of the second magnetic member and the third magnetic member of the same magnetic assembly are reversed to each other, and polarized directions of the first magnetic members of the two magnetic assemblies are reversed to each other.

In some embodiments, the housing comprises a bottom plate and a side wall extending from a periphery of the bottom plate toward the cover, the bottom plate defines a recess facing the coil to provide a space for vibration of the coil in the vibrating direction, the two magnetic assemblies are mounted on the bottom plate and located at opposite sides of the recess, and the side wall surrounds the two magnetic assemblies.

In some embodiments, the cover comprises a surface facing the coil, a protrusion protrudes from the surface in the vibrating direction, and the coil is fixed to the protrusion.

Compared with the related art, in the electromagnetic driving device of the present disclosure, one of the cover and the housing is contacted and fixed to the panel, and the coil and the magnetic assembly are respectively fixed to the cover and the housing. The coil and the magnetic assembly generate an electromagnetic driving force which directly drives the cover and the panel to vibrate and generate sound. The above structure can obtain a flatter electromagnetic driving force and a stable driving force output, and reduce assembly requirements. The magnetic suction force between the panel and the magnetic assembly is balanced and the requirements on the panel are reduced. The electromagnetic driving device of the present disclosure is applicable to panels of different types of screens. The side wall of the housing and the second and third magnetic members cooperate to reduce the magnetic leakage. Thus, a magnet field with high usage efficiency is achieved and interference of the magnet field with other components is avoided. The attenuation of the high frequency performance is reduced and the acoustic performance of the acoustic screens is improved.

### BRIEF DESCRIPTION OF THE DRAWINGS

In order to explain the technical solutions of the embodiments of the present disclosure more clearly, accompanying drawings used to describe the embodiments are briefly introduced below. It is evident that the drawings in the following description are only concerned with some embodiments of the present disclosure. For those skilled in the art, in a case where no inventive effort is made, other drawings may be obtained based on these drawings.

FIG. 1 is a schematic view of an electromagnetic driving device in accordance with an exemplary embodiment of the present disclosure;

FIG. 2 is an exploded view of a driving unit of the electromagnetic driving device of FIG. 1,

FIG. 3 is a cross-sectional view taken along line A-A of FIG. 1; and

FIG. 4 is a cross-sectional view of an electromagnetic driving device according to an alternative embodiment of the present disclosure.

### DESCRIPTION OF THE EMBODIMENTS

The present disclosure will be further illustrated with reference to the accompanying drawings. It shall be noted that the elements of similar structures or functions are represented by like reference numerals throughout the figures. The embodiments described herein are not intended as an exhaustive illustration or description of various other embodiments or as a limitation on the scope of the claims or the scope of some other embodiments that are apparent to one of ordinary skills in the art in view of the embodiments described in the Application. In addition, an illustrated embodiment need not have all the aspects or advantages shown.

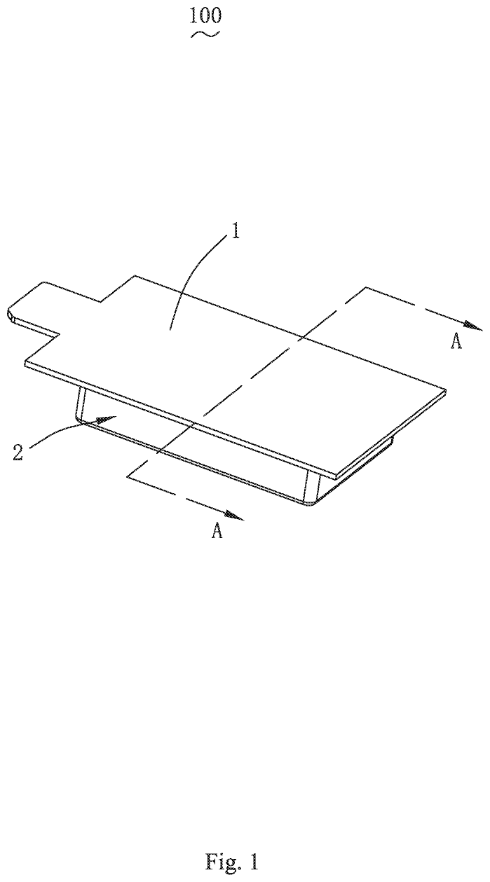

Referring to FIG. 1, an electromagnetic driving device 100 in accordance with an exemplary embodiment of the present disclosure comprises a panel 1, and an electromagnetic driver 2 attached to the panel 1 for driving the panel 1 to vibrate and sound.

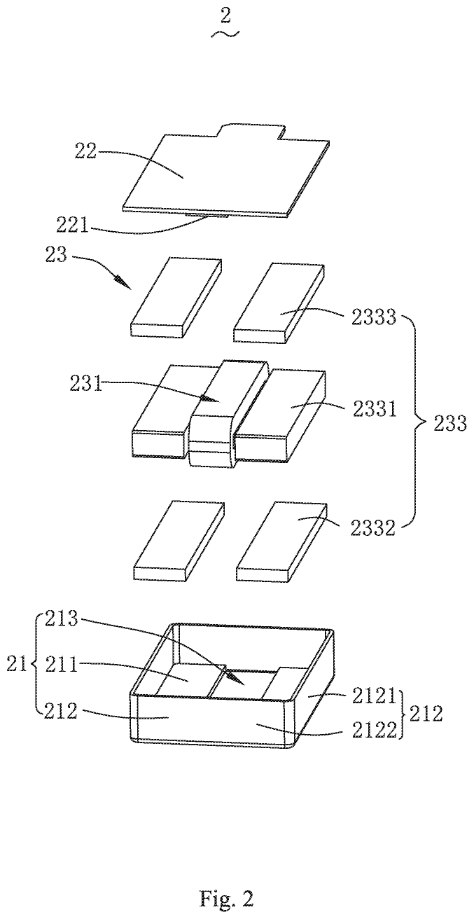

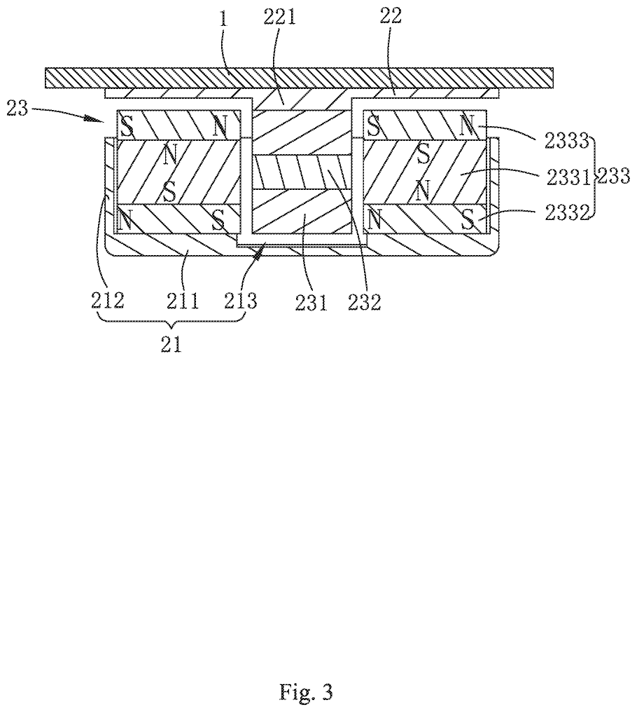

Referring to FIGS. 2 and 3, the electromagnetic driver 2 comprises a housing 21, a cover 22 spaced from the housing 21, and a driving unit 23 arranged between the housing 21 and the cover 22. One of the housing 21 and the cover 22 is fixed to the panel 1. In this embodiment, the cover 22 is plate-shaped which is fixed to and closely contacts the panel 1.

Specifically, the housing 21 includes a bottom plate 211, and a side wall 212 extending from the periphery of the bottom plate 211 toward the cover 22. The side wall 212 is spaced from the cover 22. A recess 213 is formed in a surface of the bottom plate 211 facing the cover 22. The recess 213 extends from the surface of the bottom plate 211 in a direction away from the cover 22.

In the illustrated embodiment, the bottom plate 211 has a rectangular shape. The side wall 212 comprises a pair of first side plates 2121 spaced from each other, and a pair of second side plates 2122 spaced from each other and respectively connected between the pair of first side plates 2121. The recess 213 extends from one of the second side plates 2122 to the other of the second side plates 2122.

The driving unit 23 comprises a coil 231 fixed to the cover 22, a iron core 232 around which the coil 231 is wound, and at least one magnetic assembly 233 fixed to the housing 21.

The coil 231 defines an axial direction around which the coil 231 is wound. The axil direction of the coil 231 is perpendicular to a vibrating direction of the panel 1. In this exemplary embodiment, the first side plate 2121 is perpendicular to the axil direction of the coil 2311, and the bottom plate 211 and the cover 22 are parallel to the axil direction of the coil 231. The coil 231 comprises an upper part facing and fixed to the cover 22, and a lower part away from the cover 22. The lower part of the coil 231 facing the bottom plate 231 of the housing 2 is spaced apart from the bottom plate 231 1 in the vibration direction.

The magnetic assembly 233 comprises a first magnetic member 2331, a second magnetic member 2332 and a third magnetic member 2333. The first magnetic member 2331 is sandwiched between the second magnetic member 2332 and the third magnetic member 2333 in the vibrating direction. In the illustrated embodiment, the first magnetic member 2331 is implemented as a main magnetic member 2331, and the second magnetic member 2332 and the third magnetic member 2333 are implemented as auxiliary magnetic members. In this embodiment, there are two such magnetic assemblies 233 that are respectively located on opposite sides of the recess 213. The coil 231 is disposed between the two magnetic assemblies 233 in the axial direction of the coil 231, with axial gaps formed between the coil 231 and the magnetic assemblies 233 such that the coil 231 is movable relative to the magnetic assemblies 233 in the vibrating direction. Understandably, the number of the magnetic assemblies 233 can be four, six or other even numbers. The side wall 212 of the housing 21 made of magnetic conductive material is disposed to surround the magnetic assemblies 233, which can reduce magnetic leakage and hence enhance usage efficiency of the magnetic field of the magnetic assemblies 233. As a result, the driving force of the driving unit 23 can be increased, such that the acoustic effect of the sound generated by vibration of the panel 1 can be improved.

In the illustrated embodiment, an orthographic projection of the coil 231 on the housing 211 in the vibrating direction completely falls within the periphery of the recess 213. The recess 213 in the bottom plate 211 provides a space for vibration of the coil 231 in the vibrating direction and prevents the coil 231 from bumping against the bottom plate 211 to generate noise during vibration, which further improves the acoustic effect of the sound generated by vibration of the screen. Furthermore, the provision of the recess 213 can reduce magnetic leakage through the bottom wall 211.

Preferably, a protrusion 221 protrudes from a surface of the cover 22 facing the coil 231 in the vibrating direction, and the coil 231 is fixed to the protrusion 221. With the provision of the protrusion 221, the upper part of the coil 231 can be disposed at the same level or lower than an upper surface of each magnetic assembly 233, such that an orthographic projection of the coil 231 in the axial direction onto the magnetic assembly 233 falls completely within the periphery of the magnetic assembly 233, which further increases the magnetic driving force of the driving unit 23.

In this embodiment, the first magnetic member 2331 is a permanent magnet such as a ferrite magnet or a rare earth magnet. The first magnetic member 2331 is polarized in the vibrating direction of the coil 231. The second magnetic member 2332 and the third magnetic member 2333 are also permanent magnets. The second magnetic member 2332 and the third magnetic member 2333 are fixed to opposite ends of the first magnetic member 2331 along the vibrating direction. The second magnetic member 2332 is fixed to the housing 21, for example, fixed to the bottom plate 211 of the housing 21. The third magnetic member 2333 faces the cover 22 with a gap formed therebetween in the vibrating direction.

The second magnetic member 2332 faces one side of the coil 231 with the axial gap formed therebetween. The third magnetic member 2333 faces the other side of the coil 231 with the axial gap formed therebetween. The second magnetic member 2332 and the third magnetic member 2333 are polarized in the axial direction of the coil 231. The polarity of an end of the second magnetic member 2332 near the coil 231 is the same as the polarity of one end of the first magnetic member 2331 near the second magnetic member 2332, and the polarity of an end of the third magnetic member 2333 near the coil 231 is the same as the polarity of the other end of the first magnetic member 2331 near the third magnetic member 2333. The second magnetic member 2332 and the third magnetic member 2333 are configured to conduct magnetic flux from one end of the first magnetic member 2331 to one part of the coil 231 and back to the other end of the first magnetic member 2331 from the other part of the coil 231.

In this embodiment, the magnetization directions of the first magnetic members 2331 of the two magnetic assemblies 233 are opposite to each other. For example, as shown in FIG. 3, the end of the left first magnetic member 2331 facing the cover 22 is a north pole, and the end of the left first magnetic member 2331 facing the bottom plate 211 is a south pole; the end of the right first magnetic member 2331 facing the cover 22 is a south pole, and the end of the right first magnetic member 2331 facing the bottom plate 211 is a north pole.

In this embodiment, the second magnetic member 2332 and the third magnetic member 2333 are implemented as permanent magnets. The magnetization directions of the second magnetic member 2332 and the third magnetic member 2333 are opposite to each other and are each perpendicular to the vibrating direction. For example, in the same magnetic assembly 233 at the left side of the coil 231, the end of the second magnetic member 2332 adjacent the coil 231 is a south pole, and the end of the second magnetic member 2332 away from the coil 231 is a north pole; the end of the third magnetic member 2333 adjacent the coil 231 is a north pole, and the end of the third magnetic member 2333 away from the coil 231 is a south pole.

Two ends of the two second magnetic members 2332 of the two magnetic assemblies 233 facing the same part of the coil 231 have opposite polarity. For example, as shown in FIG. 3, for the two first magnetic members 2332 in the two magnetic assemblies 233 respectively located on left and right sides of the coil 231, the end of the second magnetic member 2332 located on the left side of the coil 231 facing the coil 231 is a south pole, and the end of the second magnetic member 2332 located on the left side of the coil 231 away from the coil 231 is a north pole; the end of the second magnetic member 2332 located on the right side of the coil 231 facing the coil 231 is a north pole, and the end of the second magnetic member 2332 located on the right side of the coil 231 away from the coil 231 is a south pole. Magnetic flux emitted from the north pole of the second magnetic member 2332 located on the right side of the coil 231 arrives at the south pole of the second magnetic member 2332 located on the left side of the coil 231 after passing through the lower part of the coil 231.

Two ends of the two third magnetic members 2333 of the two magnetic assemblies 233 facing the same part of the coil 231 have opposite polarity. For example, as shown in FIG. 3, for the two third magnetic members 2333 in the two magnetic assemblies 233 respectively located on left and right sides of the coil 231, the end of the third magnetic member 2333 located on the left side of the coil 231 facing the coil 231 is a north pole, and the end of the third magnetic member 2333 located on the right side of the coil 231 away from the coil 231 is a south pole; the end of the third magnetic member 2333 located on the right side of the coil 231 facing the coil 231 is a south pole, and the end of the third magnetic member 2333 located on the right side of the coil 231 away from the coil 231 is a north pole. Magnetic flux emitted from the north pole of the third magnetic member 2333 located on the left side of the coil 231 arrives at the south pole of the third magnetic member 2333 located on the right side of the coil 231 after passing through the upper part of the coil 231.

During operation, an alternating current is applied to the coil 231 which is therefore driven by the magnetic field generated by the magnetic assemblies 233 to vibrate in the vibrating direction, thereby driving the cover 22 and the panel 1 to vibrate and sound.

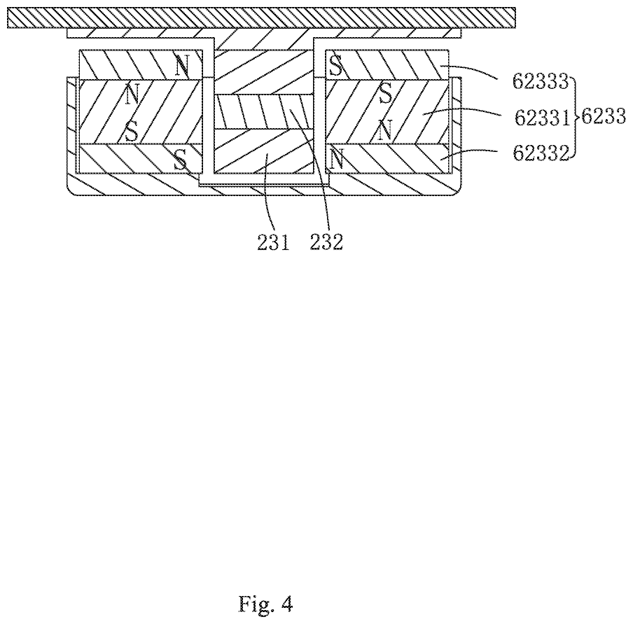

Referring to FIG. 4, according to an alternative embodiment, the first magnetic member 62331 is a permanent magnet, while the second magnetic member 62332 and the third magnetic member 62333 are implemented as magnet conductive members made of a magnetic conductive material such as iron. The working principle of the alternative embodiment is similar to that of the embodiment described above. Each of the second magnetic member 62332 and the third magnetic member 62333 is magnetized by the first magnetic members 62331 being of permanent magnets. For example, in the same magnetic assembly 6233 on the left side of the coil 6231, the end of the second magnetic member 62332 adjacent the coil 6231 is magnetized to form a south pole, and the end of the third magnetic member 62333 adjacent the coil 6231 is magnetized to form a north pole. Except for the second magnetic member 62332 and the third magnetic member 62333, the other components in the alternative embodiment are the same as in the embodiment described above and therefore explanations thereof are not repeated.

Understandably, when the second magnetic member 2332 and the third magnetic member 2333 are made of permanent magnet material, the first magnetic member 2331 may be made of a magnetic conductive material and configured to conduct magnetic flux from one of the second magnetic member 2332 and the third magnetic member 2333 to the other of the second magnetic member 2332 and the third magnetic member 2333.

Referring again to FIGS. 1-3, the iron coreless driving unit 23 can provide a more flat magnetic field driving force and a more stable output, which reduces the assembly requirements and does not cause too much attenuation of high-frequency performance. At the same time, the magnetic suction force between the panel 1 and the magnetic assembly 233 is balanced and the requirements on the panel 1 are therefore reduced, which makes the electromagnetic driver 2 suitable for various types of screens such as hard OLED screen, soft OLED screen, or LCD, and improves the reliability of the screens. The magnetic circuit of the magnetic assembly 233 can be split or used together according to different application scenarios. The side wall 212 of the housing 21 and the second magnetic member 2332 and the third magnetic member 2333 cooperate to reduce magnetic leakage, thereby achieving a high-efficiency magnetic field and avoiding interference with other components.

In order to further improve the driving force and optimize the effect of sound generation by vibrating the screen, in the electromagnetic driving device 100 of the present disclosure, the driving unit 23 may further comprise a magnetic core 232, and the coil 231 is wound around the magnetic core 232. The magnetic core 232 is made of magnetic conductive material such as iron.

For the same magnetic assembly 233, magnetic flux emitted from one of the second magnetic member 2332 and the third magnetic member 2333 passes through one part of the coil 231 and enters into the other of the second magnetic member 2332 and the third magnetic member 2333 after passing through the other part of the coil 231. During operation, the coil 231 is charged with an alternating current, and a first driving force in the vibrating direction is formed between the coil 231 and the magnetic field generated by magnetic assemblies 233. After the coil 231 is energized, the coil 231 generates an induced magnetic field passing through the magnetic core 232. The magnetic core 232 produces an electromagnet effect and becomes an electromagnet, the polarization direction of which is along the axial direction of the coil 231. The magnetic core 232 interacts with the magnetic assemblies 233 to produce a second driving force in the vibrating direction. The first driving force and the second driving force are superimposed and the directions of the first driving force and the second driving force are the same, thereby further increasing the efficiency of the magnetic field and improving the acoustic effect of the sound generated by vibration of the panel 1.

More preferably, the surface of the magnetic core 232 is plated with copper or a copper ring is attached around the magnetic core 232 to form a short-circuit ring in order to solve the problem of high frequency performance attenuation.

When the magnetic assembly 233 includes the magnetic core such as an iron core, a higher magnetic field driving force can be obtained. The high frequency performance may be attenuated to some extent due to the use of the iron core 232, and the short-circuit ring can be formed to effectively address the high frequency performance attenuation issue.

Compared with the related art, in the electromagnetic driving device of the present disclosure, one of the cover and the housing is fixed to the panel, and the coil and the magnetic assemblies are respectively fixed to the cover and the housing. The coil and the magnetic assemblies cooperate to generate an electromagnetic driving force which directly drives the cover to vibrate. The vibrating cover in turn drives the panel to vibrate and generate sound. The electromagnetic driving device of the present disclosure can obtain a more flat electromagnetic driving force and a more stable driving force output, thus reducing the assembly requirements of the screen and frame of the mobile terminal using the electromagnetic driving device of the present disclosure. The magnetic suction force between the panel and the magnetic assemblies is balanced and the requirements on the panel are reduced, which makes the electromagnetic driving device of the present disclosure suitable for panels of various types of screens. The side wall of the housing and the second and third magnetic members are provided to reduce the magnetic leakage, such that a high usage efficiency magnet field can be achieved without interfering with other components of the mobile terminal. In addition, the attenuation of the high frequency performance is reduced, and the acoustic effect of the sound generation by vibrating the panel is improved.

Although the invention is described with reference to one or more embodiments, the above description of the embodiments is used only to enable people skilled in the art to practice or use the invention. It should be appreciated by those skilled in the art that various modifications are possible without departing from the spirit or scope of the present invention. The embodiments illustrated above should not be interpreted as limits to the present invention, and the scope of the invention is to be determined by reference to the claims that follow.

What is claimed is:

1. An electromagnetic driving device comprising:
a panel; and
an electromagnetic driver attached to the panel and configured to drive the panel to vibrate in a vibrating direction and sound, the electromagnetic driver comprising a housing, a cover spaced from the housing, and a driving unit disposed between the housing and the cover, one of the housing and the cover being attached to the panel;
wherein the driving unit comprises a magnetic core made of magnetic conductive material, a coil wound around the magnetic core and mounted to the cover with a gap formed between the coil and the housing, and at least two magnetic assemblies mounted to the housing, the coil defining an axial direction around which the coil is wound, the axial direction being perpendicular to the vibrating direction, the at least two magnetic assemblies being disposed at opposite sides of the coil in the axial direction, magnetic flux emitted from one of the at least two magnetic assemblies arriving at the other of the at least two magnetic assemblies after passing through the coil.

2. The electromagnetic driving device of claim 1, wherein the magnetic core is made of iron.

3. The electromagnetic driving device of claim 2, wherein the magnetic core comprises a surface on which a layer of copper is covered to form a short-circuit ring.

4. The electromagnetic driving device of claim 1, wherein the coil comprises two parts arranged in the vibrating direction, the magnetic assembly comprises a first magnetic member, a second magnetic member and a third magnetic member, the first magnetic member being sandwiched between the second magnetic member and the third magnetic member in the vibrating direction, the second magnetic member and the third magnetic member respectively facing the two parts of the coil in the axial direction.

5. The electromagnetic driving device of claim 4, wherein the first magnetic member is polarized in the vibrating direction, and the second magnetic member and the third magnetic member are polarized in the axial direction of the coil, polarized directions of the second magnetic member and the third magnetic member of the same magnetic assembly being reversed to each other.

6. The electromagnetic driving device of claim 5, wherein the first magnetic member is a permanent magnet, and the second and third magnetic members are made of permanent magnet material or magnetic conductive material.

7. The electromagnetic driving device of claim 5, wherein the first magnetic member is made of magnetic conductive material, and the second and third magnetic members are made of permanent magnet material.

8. The electromagnetic driving device of claim 5, wherein polarized directions of the first magnetic members of the at least two magnetic assemblies are reversed to each other.

9. The electromagnetic driving device of claim 1, wherein the housing comprises a bottom plate and a side wall extending from a periphery of the bottom plate toward the cover, the bottom plate defining a recess for forming the gap between the coil and the bottom plate of the housing, the side wall surrounding the driving unit.

10. The electromagnetic driving device of claim 9, wherein the bottom plate has a rectangular shape, the side wall comprises a pair of first side plates and a pair of second side plates connected between the first side plates, the recessing extending from one of the second side plates to the other of the second side plates.

11. The electromagnetic driving device of claim 9, wherein the cover comprises a surface facing the coil, a protrusion protrudes from the surface in the vibrating direction, and the coil is fixed to the protrusion.

12. The electromagnetic driving device of claim 9, wherein an orthographic projection of the coil on the magnetic assembly in the axial direction falls into a periphery of the magnetic assembly.

13. The electromagnetic driving device of claim 1, wherein the panel is a panel of a screen of a mobile terminal device.

14. An electromagnetic driver configured to drive a screen of a mobile terminal device to vibrate and sound, the electromagnetic driver comprising:
a housing;
a driving unit received in the housing; and
a cover covering the driving unit;
wherein the driving unit comprises a coil mounted to the cover, and two magnetic assemblies mounted to the housing, the coil defining an axial direction around which the coil is wound, the coil comprising two parts spaced arranged in a vibrating direction along which the coil and the cover is vibrated when the coil is energized; and
wherein each magnetic assembly comprises a first magnetic member, a second magnetic member and a third magnetic member, the first magnetic member being sandwiched between the second magnetic member and the third magnetic member in the vibrating direction, the second magnetic member and the third magnetic member respectively facing the two parts of the coil in the axial direction, magnetic flux emitted from one of the second magnetic members arriving at the other of the second magnetic members after passing through one of the two parts of the coil, magnetic flux emitted from one of the third magnetic members arriving at the other of the third magnetic members after passing through the other of the two parts of the coil.

15. The electromagnetic driver of claim 14, wherein the first magnetic member is polarized in the vibrating direction, the second magnetic member and the third magnetic member are polarized in the axial direction of the coil, polarized directions of the second magnetic member and the third magnetic member of the same magnetic assembly are reversed to each other, and polarized directions of the first magnetic members of the two magnetic assemblies are reversed to each other.

16. The electromagnetic driver of claim 14, wherein the housing comprises a bottom plate and a side wall extending from a periphery of the bottom plate toward the cover, the bottom plate defines a recess facing the coil to provide a space for vibration of the coil in the vibrating direction, the two magnetic assemblies are mounted on the bottom plate and located at opposite sides of the recess, and the side wall surrounds the two magnetic assemblies.

17. The electromagnetic driver of claim 14, wherein the cover comprises a surface facing the coil, a protrusion protrudes from the surface in the vibrating direction, and the coil is fixed to the protrusion.
